(19) United States
(12) Patent Application Publication
(10) Pub. No.: US 2014/0333113 A1
(43) Pub. Date: Nov. 13, 2014

(54) VEHICLE SEAT SUPPORTING DEVICE

(71) Applicants: TS TECH CO., LTD., ASAKA-SHI (JP); HONDA MOTOR CO., LTD., TOKYO (JP)

(72) Inventors: Hiroshi IZAWA, Shioya-Gun (JP); Manabu MATSUMOTO, Wako-Shi (JP); Masanobu TAKASE, Wako-Shi (JP); Muneatsu MINATO, Wako-Shi (JP)

(73) Assignees: TS TECH CO., LTD., ASAKA-SHI (JP); HONDA MOTOR CO., LTD., TOKYO (JP)

(21) Appl. No.: 14/272,659

(22) Filed: May 8, 2014

(30) Foreign Application Priority Data
May 10, 2013 (JP) 2013-100562

(51) Int. Cl. B60N 2/015

(52) U.S. Cl. CPC B60N 2/015
USPC 297/463.1

(57) ABSTRACT

To reinforce, with a reinforcing member, a foot bracket which supports a seat on a vehicle body floor, and to suppress increase in a size of the foot bracket due to use of the reinforcing member, left and right end portions of the reinforcing member for reinforcing the foot bracket are fixed to the foot bracket, the foot bracket fixed on the vehicle body floor and supporting a seat supporting part of the seat. An intermediate portion of the reinforcing member, which is a main part thereof, is situated within a projection plane in an up-down direction of the foot bracket. A straight portion of the reinforcing member corresponding to a fixing portion for fixing the foot bracket to the vehicle body floor is disposed on the seat supporting part side of the foot bracket.

### CROSS REFERENCES TO RELATED APPLICATIONS

The present application claims priority under 35 U.S.C. §119 to Japanese Patent Application No. 2013-100562 filed May 10, 2013 the entire contents of which are hereby incorporated by reference.

### BACKGROUND OF THE INVENTION

1. Field of the Invention

The present invention relates to a vehicle seat supporting device in which a foot bracket is installed on a vehicle body floor of a vehicle such as an automobile and the like and a seat is supported on the foot bracket, in particular, relates to a vehicle seat supporting device capable of enhancing rigidity of the foot bracket to firmly and stably support the seat while suppressing increase in a size of the foot bracket.

2. Description of the Related Art

There has been a conventionally known vehicle seat supporting device in which a leg bracket (foot bracket) 2 is installed on a vehicle body floor and a seat is supported on the vehicle body floor through the leg bracket 2 and a seat slide apparatus (a lower rail 3, an upper rail 4) (see International Publication No. WO2009/028535).

### SUMMARY OF THE INVENTION

Meanwhile, to stably support the seat, on which an occupant sits, on the vehicle body floor with the foot bracket, it is conceivable to use reinforcing means to reinforce and enhance rigidity of the foot bracket so as to suppress deformation and distortion of the foot bracket. However, such an approach increases a size of the foot bracket, so that the foot bracket occupies a narrow dead space under the seat. This leads to problems such as making it difficult for the occupant to move around the seat, affecting attachment and layout of other parts, increasing cost of the foot bracket itself, and the like.

The present invention has been made in view of the above circumstance, and an object thereof is to provide a novel vehicle seat supporting device capable of solving the above problems by significantly enhancing rigidity of a foot bracket while suppressing increase in the size of the foot bracket.

In order to achieve the object, according to a first aspect of the present invention, there is provided a vehicle seat supporting device which supports a seat on a seat supporting part of a foot bracket fixed on a vehicle body floor, wherein left and right end portions of a reinforcing member for reinforcing the foot bracket are fixed to the foot bracket, and an intermediate portion of the reinforcing member connecting the left and right end portions is situated within a projection plane in an up-down direction of the foot bracket, and a portion of the intermediate portion corresponding to a fixing portion for fixing the foot bracket to the vehicle body floor is disposed on a side closer to the seat supporting part than the fixing portion.

According to the first aspect of the present invention, the intermediate portion connecting the left and right end portions of the reinforcing member for reinforcing the foot bracket is situated within the projection plane in the up-down direction of the foot bracket. Thus, the intermediate portion, which is a main part of the reinforcing member for reinforcing the foot bracket, does not stick out of the foot bracket. Accordingly, increase in the size of the foot bracket can be suppressed although the foot bracket is reinforced by using the reinforcing member. Moreover, since the portion of the intermediate portion corresponding to the fixing portion for fixing the foot bracket to the vehicle body floor is disposed on the side closer to the sheet supporting part than the fixing portion, reinforcing effect of the foot bracket by the reinforcing member can be further enhanced, and also the reinforcing member is prevented from blocking fixing of the foot bracket to the vehicle body floor.

According to a second aspect of the present invention, in addition to the first aspect, the left and right end portions of the reinforcing member fixed to the foot bracket extend in a front-rear direction of the foot bracket.

According to the second aspect of the present invention, the left and right end portions of the reinforcing member fixed to the foot bracket extend in the front-rear direction of the foot bracket. Accordingly, they can increase strength of the reinforcing member itself and therefore further enhance the rigidity of the foot bracket.

According to a third aspect of the present invention, in addition to the first aspect, a cover member for covering the foot bracket is attached to the foot bracket by being placed in slidable engagement with the reinforcing member.

According to the third aspect of the present invention, the cover member for covering the foot bracket is attached to the foot bracket by being placed in slidable engagement with the reinforcing member. Thus, the reinforcing member can be used as a guide for the attachment of the cover member to the foot bracket. Accordingly, attachability of the cover member can be improved.

According to a fourth aspect of the present invention, in addition to the first aspect, left and right end portions of the foot bracket respectively have left and right side wall portions formed with reinforcing ribs, and to at least one of the side wall portions, a corresponding one of the end portions of the reinforcing member is fixed.

According to the fourth aspect of the present invention, the left and right end portions of the foot bracket respectively have the left and right side wall portions formed with the reinforcing ribs, and, to at least the one of the side wall portions, the corresponding one of the end portions of the reinforcing member is fixed. Accordingly, the reinforcing member can be stably fixed to the foot bracket.

According to a fifth aspect of the present invention, in addition to the first aspect, at least one of the left and right end portions of the reinforcing member extends along a corresponding one of the left and right side wall portions of the foot bracket.

According to the fifth aspect of the present invention, at least the one of the left and right end portions of the reinforcing member extends along the corresponding side wall portion of the foot bracket. Accordingly, the reinforcing member can be fixed to the foot bracket stably and also compactly.

According to a sixth aspect of the present invention, in addition to the first aspect, at least one of the left and right side wall portions of the foot bracket is provided with a sinkage suppressing portion for suppressing sinkage of the foot bracket.

According to the sixth aspect of the present invention, at least the one of the left and right side wall portions of the foot bracket is provided with the sinkage suppressing portion for suppressing the sinkage of the foot bracket so as to improve the rigidity of the foot bracket in combination with the reinforcing member reinforcing the foot bracket. Accordingly, suppressing effect of sinking deformation can be further enhanced.

According to a seventh aspect of the present invention, in addition to the first aspect, the reinforcing member is formed of a wire.

According to the seventh aspect of the present invention, the reinforcing member is formed of a wire. Accordingly, the reinforcing member is easy to manufacture and the manufacturing cost thereof can be lowered.

According to an eighth aspect of the present invention, in addition to the third aspect, the cover member for covering the foot bracket is attached to the foot bracket, and has an engagement portion which is placed in slidable engagement with the reinforcing member.

According to the eighth aspect of the present invention, the cover member for covering the foot bracket is attached to the foot bracket, and has the engagement portion which is placed in slidable engagement with the reinforcing member. Accordingly, the attachment of the cover member to the foot bracket can be made easy, and in addition the rigidity of the over member can be enhanced by the engagement portion.

According to a ninth aspect of the present invention, in addition to the eighth aspect, a plurality of the engagement portions are formed respectively on engagement plates formed integrally with the cover member.

According to the ninth aspect of the present invention, the plurality of the engagement portions are formed respectively on the engagement plates formed integrally with the cover member. Accordingly, the rigidity of the cover member can be further enhanced.

The above and other objects, characteristics and advantages of the present invention will be clear from detailed descriptions of the preferred embodiment which will be provided below while referring to the attached drawings.

### BRIEF DESCRIPTION OF THE DRAWINGS

FIG. 1 is an entire perspective view of a seat.

FIG. 2 is a perspective view of a foot bracket and a cover member as seen from the direction of arrow 2 in FIG. 1.

FIG. 3 is an exploded perspective view of the foot bracket and the cover member.

FIG. 4 is a perspective view of the foot bracket and the cover member as seen from the direction of arrow 4 in FIG. 1.

FIG. 5 is an enlarged perspective view of the cover member as seen from the direction of arrow 5 in FIG. 4.

FIG. 6 is an enlarged sectional view taken along line 6-6 in FIG. 2.

FIG. 7 is an enlarged sectional view taken along line 7-7 in FIG. 2.

FIG. 8 is an enlarged sectional view taken along line 8-8 in FIG. 2.

### DESCRIPTION OF THE PREFERRED EMBODIMENT

An embodiment in which a vehicle seat supporting device of the present invention is applied to an automobile will be described.

In the following description, front, rear, left, right, upper, and lower sides of the automobile in which a seat is installed will be expressed as “front,” “rear,” “left,” “right,” “upper,” and “lower,” respectively.

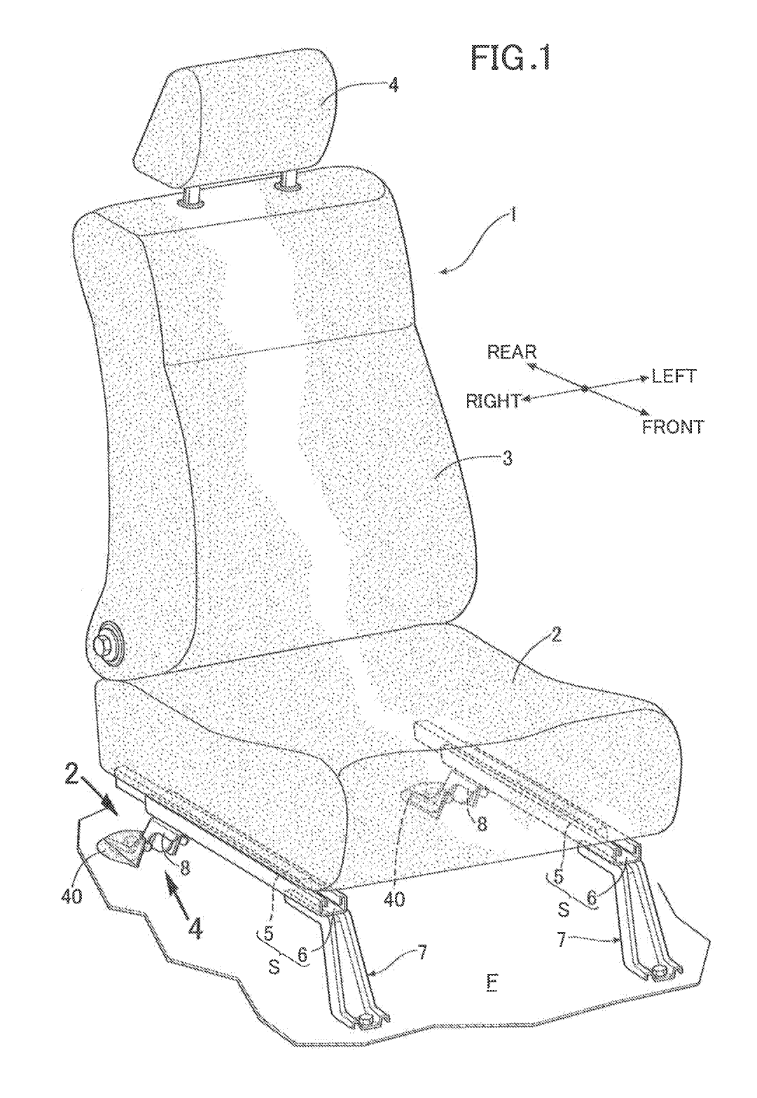

As shown in FIG. 1, an automobile seat 1 includes: a seat cushion 2 for an occupant to sit on; a seatback 3 supported on a rear portion of this seat cushion 2 in such a way as to be capable of reclining in a front-rear direction by means of a conventionally known reclining mechanism (not shown); and a headrest 4 supported on an upper portion of the seatback 3 in such a way as to be adjustable in height by being lifted and lowered.

The seat 1 is supported, via slide rail mechanisms S and above the vehicle body floor F, on a pair of left and right front foot brackets 7 and a pair of left and right rear foot brackets 8, each pair being fixed to a vehicle body floor F with a gap therebetween in a left-right direction (vehicle width direction), in such a way as to be adjustable in position in the front-rear direction. Each slide rail mechanism S includes a lower rail 6 fixed to the front and rear foot brackets 7, 8, and an upper rail 5 fixed to a lower surface of the seat cushion 2 and engaged with the lower rail 6 in such a way as to be slidable thereon in the front-rear direction.

The front foot brackets 7 are formed slightly higher than the rear foot brackets 8. Thus, the seat cushion 2 supported on these foot brackets 7, 8 is slightly tilted downward to its rear side.

Note that the front foot brackets 7 are conventionally known components, and their detailed description will therefore be omitted.

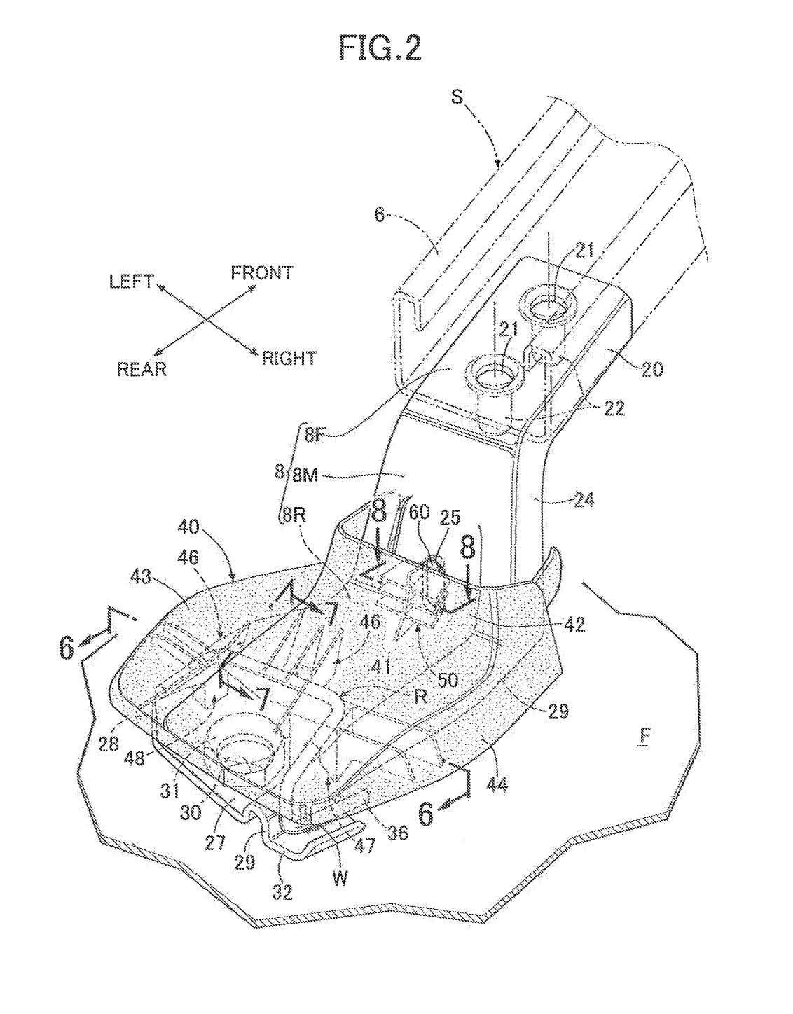

Next, a structure of one of the rear foot brackets 8 (hereinafter, simply referred to as the foot bracket) according to the present invention will be described with reference to FIGS. 2 to 8.

The pair of left and right foot brackets 8 fixed on the vehicle body floor F with a predetermined gap therebetween in the left-right direction have different structures, and the seat supporting device according to the present invention is applied to one of the foot brackets 8.

Hereinbelow, the structure of the foot bracket 8 to which the seat supporting device is applied will be described in detail.

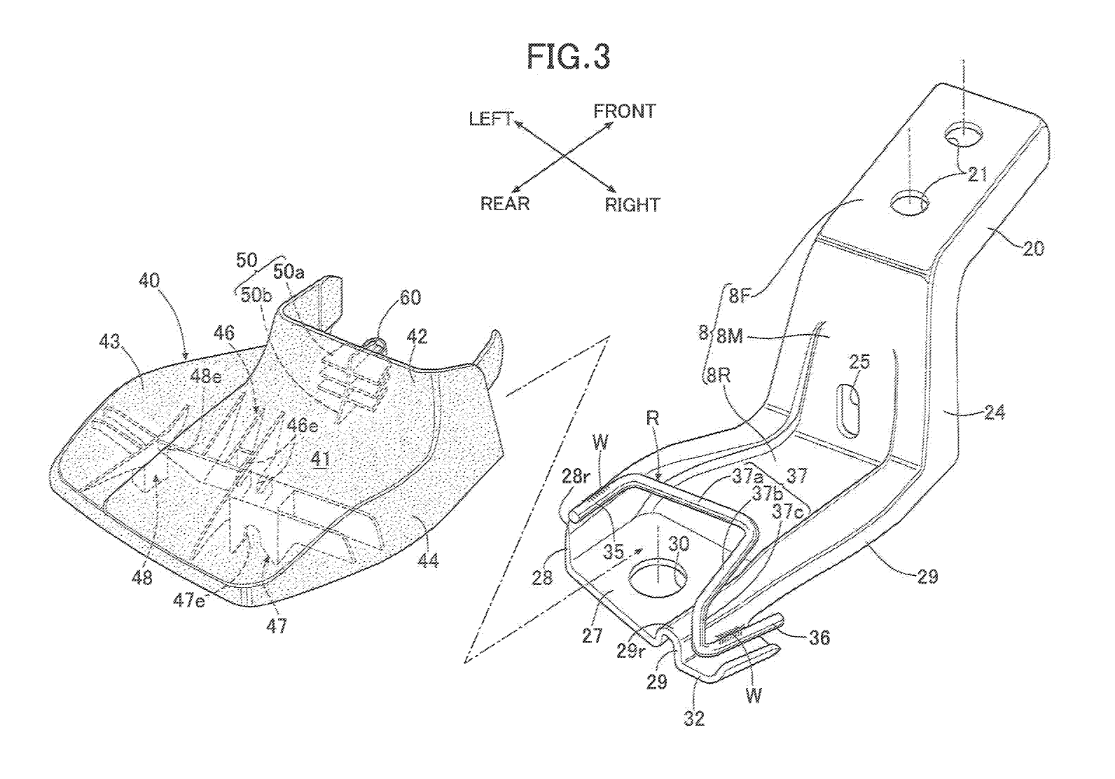

As shown in FIGS. 2 and 3, the foot bracket 8 is made of a metal sheet such as a steel sheet and the like formed in a gooseneck shape which is long in the front-rear direction as a whole. The foot bracket 8 includes: a seat attachment side part, which specifically is a front part 8F supporting the seat 1 with a gap in an up-down direction between the seat 1 and the vehicle body floor F; a vehicle-body-floor attachment side part, which specifically is a rear part 8R fixed on the vehicle body floor F; and an intermediate part 8M rising upward integrally from the rear part 8R and connecting integrally to the front part 8F.

The front part 8F of the foot bracket 8 has downwardly extending side wall portions 20 on its left and right sides, respectively, to be formed in a channel shape in cross section. Attachment holes 21 are bored in an intermediate portion of the front part 8F. Through these attachment holes 21, the front part 8F is fastened to the lower rail 6 of the slide rail mechanism S with conventionally known fastening means (such as a bolt and nut, and the like) 22 (see FIG. 2).

The intermediate part 8M of the foot bracket 8 has forwardly extending side wall portions 24 on its left and right sides, respectively, to be formed in a channel shape in cross section. The side wall portions 24 continue integrally from the side wall portions 20 of the front part 8F, respectively. Moreover, an attachment hole 25 being an elongated hole longer in the up-down direction and used for attachment of a later-described cover member 40 is bored on a lower side of a center portion of the intermediate part 8M.

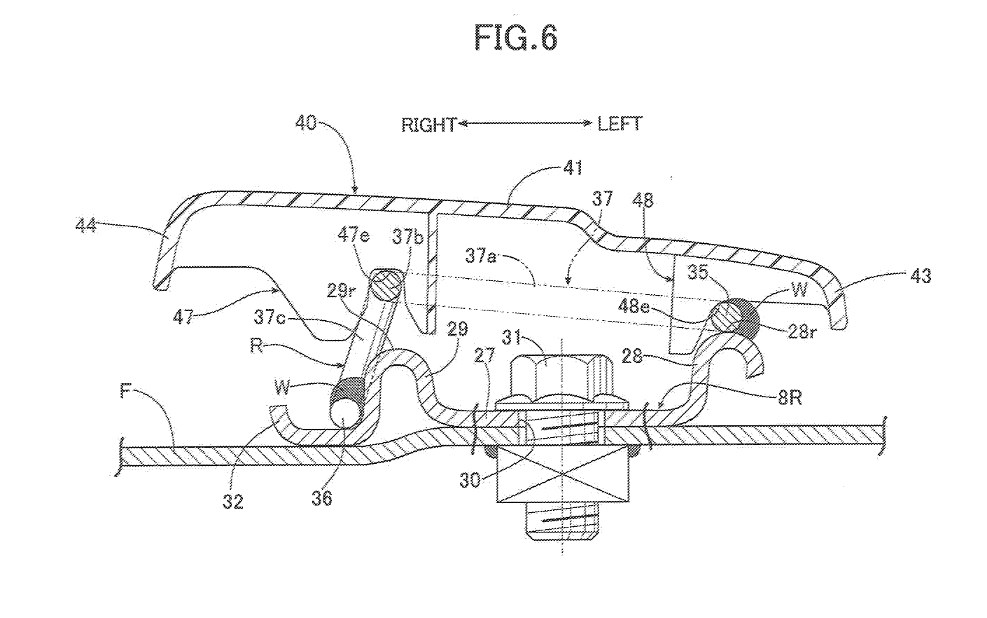

The rear part 8R of the foot bracket 8 has: an attachment plate portion 27 being substantially parallel to the vehicle body floor F and formed slightly higher at a portion thereof connected to the intermediate part 8M; and left and right side wall portions 28, 29 rising upward from left and right end portions of the attachment plate portion 27. The left and right side wall portions 28, 29 continue integrally from the left and right side wall portions 24 of the intermediate part 8M, respectively. Moreover, left and right reinforcing ribs 28r, 29r each having an upwardly protruding section are formed integrally with the left and right side wall portions 28, 29, respectively. A circular attachment hole 30 as a fixing portion is bored in a rear center portion of the attachment plate portion 27 of the rear part 8R. The rear part 8R of the foot bracket 8 is fixed to the vehicle body floor F through this attachment hole 30 with fastening means, specifically, a bolt and nut 31 (see FIG. 6).

As shown in FIGS. 3 and 6, a sinkage suppressing portion 32 which suppresses sinking deformation of the foot bracket 8 is formed integrally with the right side wall portion 29 of the rear part 8R of the foot bracket 8. This sinkage suppressing portion 32 is formed of a tongue piece having a U-shape in cross section and extending integrally from the right side wall portion 29 of the rear part 8R of the foot bracket 8 toward an outer side (toward a right side). A flat lower surface of the sinkage suppressing portion 32 is set in pressure contact with the vehicle body floor F to propagate uneven load applied to the seat 1 to the vehicle body floor F through the sinkage suppressing portion 32. In this way, the sinking deformation of the foot bracket 8 is suppressed.

Moreover, as shown in FIGS. 2 to 6, to the rear part 8R, which is an attachment end portion of the foot bracket 8 on the vehicle body floor F side, a reinforcing member R for reinforcing the foot bracket 8, in particular, the rear part 8R thereof, is fixed.

Next, a structure of this reinforcing member R will be described mainly with reference to FIG. 3.

The reinforcing member R is formed by bending a wire made of a metal wire such as a steel wire and the like, and includes left and right end portions 35, 36 extending in the front-rear direction along the left and right side wall portions 28, 29 of the rear part 8R of the foot bracket 8, respectively, and an intermediate portion 37 connecting these opposite end portions 35, 36 and located above the rear part 8R. The intermediate portion 37 forms a main part of the reinforcing member R, and includes: a portion corresponding to the attachment hole 30 serving as an attachment portion, which specifically is a straight portion 37a traversing a front side of the attachment portion 30; an inclined portion 37b extending rearward from a right end of the straight portion 37a while inclining slightly downward; and a vertical portion 37c bending downward from a rear end of the inclined portion 37b and extending downward. The intermediate portion 37 is situated within a projection plane in an up-down direction of the rear part 8R of the foot bracket 8. Moreover, the intermediate portion 37 extends toward a front side of the foot bracket 8 around the attachment hole 30, and is therefore formed in a U-shape opening toward the rear side in a plan view. In this way, the intermediate portion 37 enhances strength of the reinforcing member R, and also prevents the reinforcing member R from blocking fixing of the foot bracket 8 on the vehicle body floor F with the fastening means 31 through the attachment hole 30 which is a fixing portion.

As shown in FIGS. 3 and 6, the left end portion 35 of the reinforcing member R is welded (W) on the left side wall portion 28 of the foot bracket 8, and the right end portion 36 is welded (W) to an outer side surface of the right side wall portion 29 of the foot bracket 8. Moreover, since the intermediate portion 37, which is the main part of the reinforcing member R formed of a wire, is situated within the projection plane in the up-down direction of the rear part 8R, no portion of the intermediate portion 37 sticks out of the rear part 8R of the foot bracket 8. Hence, increase in a size of the foot bracket 8 is suppressed. Moreover, since the straight portion 37a of the intermediate portion 37, that is, the portion corresponding to the attachment hole 30, is disposed at the front side of the attachment hole 30, that is, at the seat supporting part 8F side of the foot bracket 8, reinforcing effect of the foot bracket 8 by the reinforcing member R is further enhanced.

As shown in FIG. 2, a rear half portion of the foot bracket 8 including the rear part 8R and a part of the intermediate part 8M is covered with the cover member 40. This cover member 40 is slide into engagement with the reinforcing member R from the rear side to be attached to the intermediate part 8M of the foot bracket 8.

Next, a structure of this cover member 40 will be described with reference to FIGS. 2 to 8.

The cover member 40 is integrally molded of a hard synthetic resin material, and covers the rear half portion of the foot bracket 8, which specifically is the part thereof exposed to outside, to thereby improve appearance of the seat 1 and thus improve quality of the seat 1.

The cover member 40 is open at its lower and front sides, and has an upper wall 41 inclined downward toward the rear side, a front wall 42 rising upward from the upper wall 41, and left and right side walls 43, 44 extending downward from left and right sides of the upper wall 41, respectively. The cover member 40 is formed into a shape like an upper of a shoe.

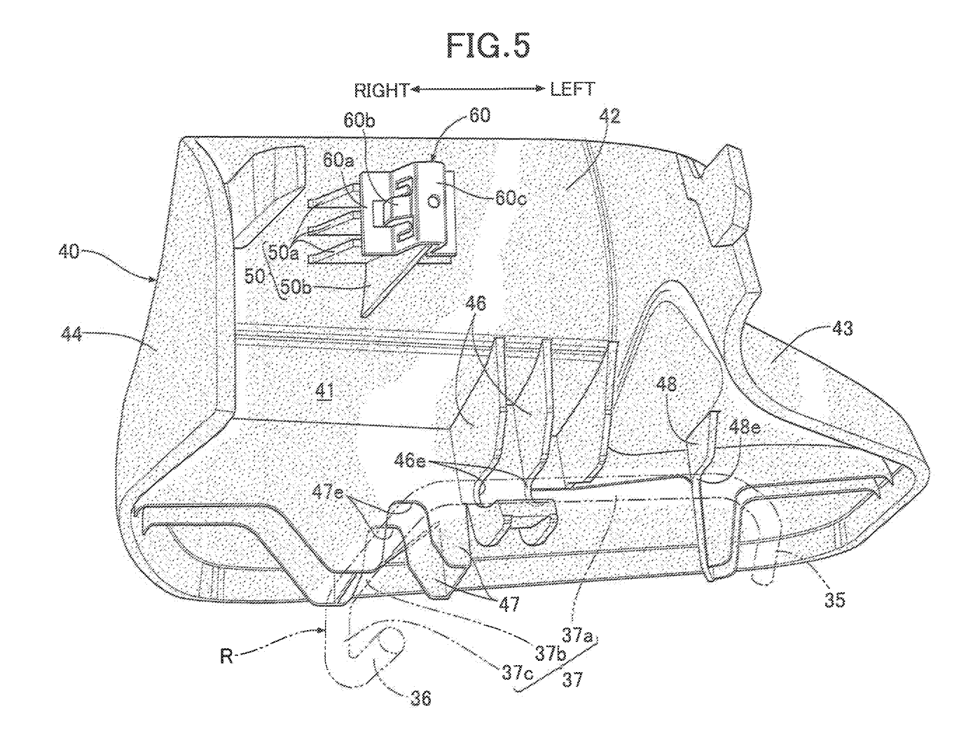

As shown most clearly in FIG. 5, a back surface of the upper wall 41 of the cover member 40 is formed integrally with:

a pair of intermediate-portion engagement plates 46 in an intermediate section of the back surface of the upper wall 41, each intermediate-portion engagement plate 46 extending toward the front side and having a hook-shaped engagement portion 46e opening toward the front side;

a pair of right engagement plates 47 in a right section of the back surface, each right engagement plate 47 extending in the left-right direction and having a hook-shaped engagement portion 47e opening toward the lower side; and

a left engagement plate 48 in a left section of the back surface, the left engagement plate 48 extending in the front-rear direction and having a L-shaped engagement portion 48e opening toward the front side.

These engagement plates 46, 47, 48 form integrally a reinforcing rib to reinforce the cover member 40.

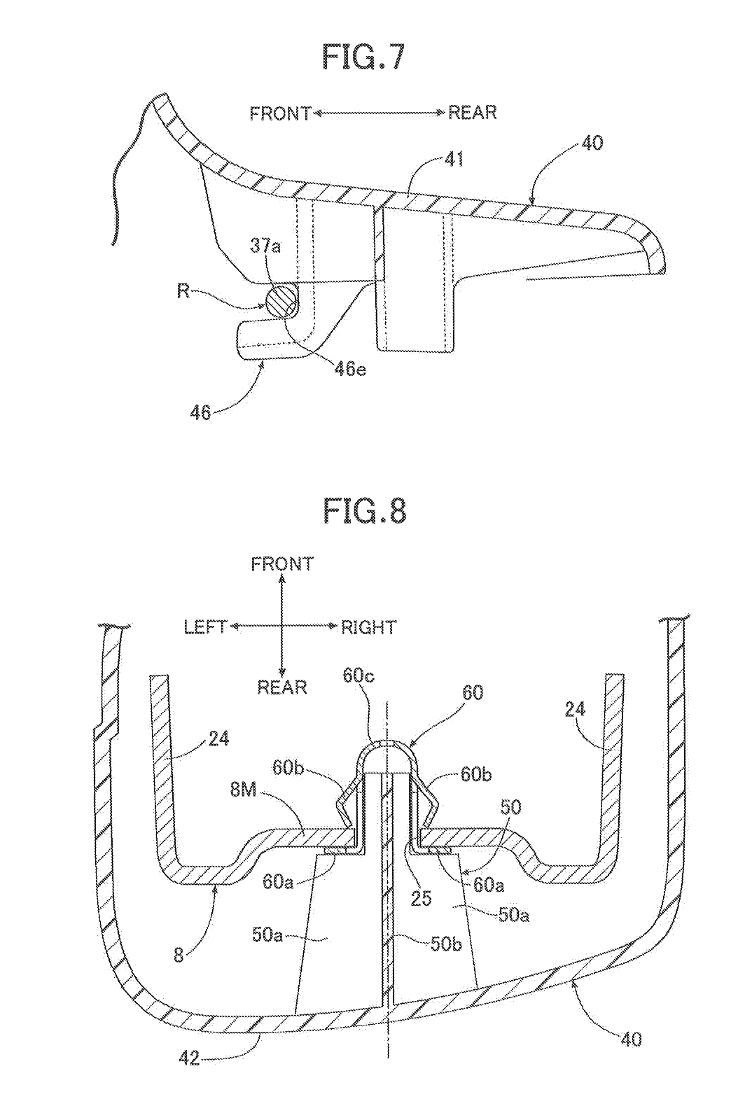

The engagement plates 46, 47, 48 are each placed in slidable and detachable engagement with the reinforcing member R, which is made of a wire, from the rear side of the foot bracket 8, to thereby be locked to the foot bracket 8. Specifically, as shown by a dashed line in FIG. 3, the cover member 40 is slid forward toward the foot bracket 8. As a result, as shown in FIGS. 2 to 7, the hook-shaped engagement portions 46e of the pair of intermediate-portion engagement plates 46 are engaged with the straight portion 37a of the intermediate portion 37 of the reinforcing member R (see FIG. 7); moreover, the hook-shaped engagement portions 47e of the pair of right engagement plates 47 are engaged with the inclined portion 37b of the intermediate portion 37 of the reinforcing member R (see FIG. 6); and furthermore, the L-shaped engagement portion 48e of the left engagement plate 48 is engaged with one side of the straight portion 37a of the intermediate portion 37 of the reinforcing member R (see FIG. 6).

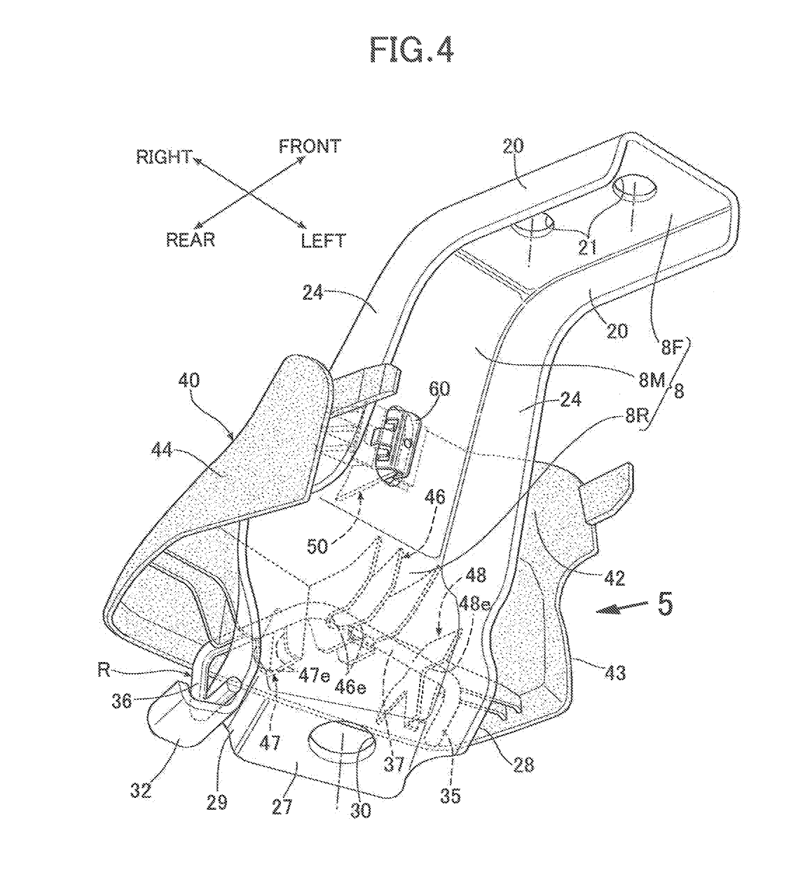

As shown in FIGS. 4, 5, and 8, on a back surface of the front wall 42 rising upward, of the cover member 40, there is provided an insertion coupling piece 60 as attachment means for attaching the cover member 40 to the foot bracket 8. This insertion coupling piece 60 is attached to an attachment plate 50 provided integrally on the back surface of the front wall 42 of the cover member 40. This attachment plate 50 is formed in a frame shape by multiple horizontal attachment plates 50a and a vertical attachment plate 50b crossing and coupled to these horizontal attachment plates 50a. The insertion coupling piece 60 is attached to an end portion of the attachment plate 50. The insertion coupling piece 60 includes an attachment portion 60a attached to the attachment plate 50, and an insertion portion 60c having a pair of dogleg-shaped spring pieces 60b for preventing detachment (see FIG. 8).

As mentioned earlier, the cover member 40 which is designed to be moved from the rear side of the foot bracket 8 toward the front side to be slide into engagement with the reinforcing member R is attached to the rear half portion of the foot bracket 8 by inserting and engaging the insertion coupling piece 60 with the attachment hole 25 of the intermediate part 8M of the foot bracket 8 (see FIGS. 2 and 4).

Since the intermediate portion 37, which is the main part of the reinforcing member R reinforcing the foot bracket 8, is situated within the projection plane in the up-down direction of the foot bracket 8, the intermediate portion 37 of the reinforcing member R reinforcing the foot bracket 8 does not stick out of the foot bracket 8. Accordingly, increase in the size of the foot bracket 8 can be suppressed although the foot bracket 8 is reinforced by using the reinforcing member R. Moreover, since the portion of the intermediate portion 37 corresponding to the fixing portion 30 for fixing the foot bracket 8 to the vehicle body floor F, that is, the straight portion 37a, is disposed on a side closer to the sheet supporting part 8F than the fixing portion 30, the reinforcing effect of the foot bracket 8 by the reinforcing member R can be further enhanced, and also the reinforcing member R is prevented from blocking the attachment of the foot bracket 8 to the vehicle body floor F.

Since the left and right end portions 35, 36 of the reinforcing member R fixed to the foot bracket 8 extend in the front-rear direction of the foot bracket 8, they can increase the strength of the reinforcing member R itself and therefore further enhance the rigidity of the foot bracket 8, without sticking out of the foot bracket 8.

Since the cover member 40 for covering the foot bracket 8 is attached to the foot bracket 8 by being placed in slidable engagement with the reinforcing member R, the reinforcing member R can be used as a guide for the attachment of the cover member 40 to the foot bracket 8. Accordingly, attachability of the cover member 40 can be improved.

Since the left and right end portions 35, 36 of the reinforcing member R are fixed respectively to the left and right side wall portions 28, 29 of the foot bracket 8 having the reinforcing ribs 28r, 29r, respectively, the reinforcing member R can be stably fixed to the foot bracket 8.

Since the right end portion 36 of the reinforcing member R extends along the right side wall portion 29 of the foot bracket 8, the reinforcing member R can be fixed to the foot bracket 8 stably and also compactly.

The right side wall portion 29 of the foot bracket 8 is provided with the sinkage suppressing portion 32 for suppressing sinkage of the foot bracket 8, and improves the rigidity of the foot bracket 8 in combination with the reinforcing member R reinforcing the foot bracket 8. Accordingly, suppressing effect of sinking deformation can be further enhanced.

Since the reinforcing member R is formed of a wire, the reinforcing member R is easy to manufacture and can therefore lower the manufacturing cost thereof.

Since the cover member 40 for covering the foot bracket 8 is attached to the foot bracket 8, and has the engagement portions 46e, 47e, 48e which are slide into engagement with the reinforcing member R, the attachment of the cover member 40 to the foot bracket 8 can be made easy, and in addition the rigidity of the cover member 40 can be enhanced by the engagement portions 46e, 47e, 48e as well.

Since the engagement portions 46e, 47e, 48e are multiple members, and these engagement portions 46e, 47e, 48e are formed respectively in the engagement plates 46, 47, 48 formed integrally with the cover member 40, the rigidity of the cover member 40 can be further enhanced.

An embodiment of the present invention has been described hereinabove, but the present invention is not limited to this embodiment, and various design changes can be made thereto without departing from the gist of the present invention.

For example, in the foregoing embodiment, the case where the vehicle seat supporting device of the present invention is applied to one of the rear foot brackets is described. However, the vehicle seat supporting device of the present can be applied to one of the front foot brackets. Moreover, in the foregoing embodiment, the case where the vehicle seat supporting device of the present invention is applied to an automobile is described. However, the vehicle seat supporting device of the present invention can be applied to different types of vehicles such as a railroad vehicle and the like, as a matter of course.

What is claimed is:

1. A vehicle seat supporting device which supports a seat on a seat supporting part of a foot bracket fixed on a vehicle body floor, wherein
left and right end portions of a reinforcing member for reinforcing the foot bracket are fixed to the foot bracket, and an intermediate portion of the reinforcing member connecting the left and right end portions is situated within a projection plane in an up-down direction of the foot bracket, and
a portion of the intermediate portion corresponding to a fixing portion for fixing the foot bracket to the vehicle body floor is disposed on a side closer to the seat supporting part than the fixing portion.

2. The vehicle seat supporting device according to claim 1, wherein the left and right end portions of the reinforcing member fixed to the foot bracket extend in a front-rear direction of the foot bracket.

3. The vehicle seat supporting device according to claim 1, wherein a cover member for covering the foot bracket is attached to the foot bracket by being placed in slidable engagement with the reinforcing member.

4. The vehicle seat supporting device according to claim 1, wherein
left and right end portions of the foot bracket respectively have left and right side wall portions formed with reinforcing ribs, and
to at least one of the side wall portions, a corresponding one of the end portions of the reinforcing member is fixed.

5. The vehicle seat supporting device according to claim 1, wherein at least one of the left and right end portions of the reinforcing member extends along a corresponding one of the left and right side wall portions of the foot bracket.

6. The vehicle seat supporting device according to claim 1, wherein at least one of the left and right side wall portions of the foot bracket is provided with a sinkage suppressing portion for suppressing sinkage of the foot bracket.

7. The vehicle seat supporting device according to claim 1, wherein the reinforcing member is formed of a wire.

8. The vehicle seat supporting device according to claim 3, wherein the cover member for covering the foot bracket is attached to the foot bracket, and has an engagement portion which is placed in slidable engagement with the reinforcing member.

9. The vehicle seat supporting device according to claim 8, wherein a plurality of the engagement portions are formed respectively on engagement plates formed integrally with the cover member.
